(19) United States
(12) Patent Application Publication
(10) Pub. No.: US 2006/0287953 A1
(43) Pub. Date: Dec. 21, 2006

(54) GLOBAL WEB-BASED FINANCIAL REMITANCE SYSTEM AND PROCESS

(75) Inventor: Tariq M. Chauhan, Dubai (AE)

Correspondence Address: MAINE & ASMUS, 100 MAIN STREET, P O BOX 3445, NASHUA, NH, 03061-3445, US

(73) Assignee: SIAMR SOLUTIONS, INC., Dubai (AE)

(21) Appl. No.: 11/424,550

(22) Filed: Jun. 16, 2006

Related U.S. Application Data
(60) Provisional application No. 60/691,032, filed on Jun. 16, 2005.

(51) Int. Cl. G06Q 40/00

(52) U.S. Cl. 705/39

(57) ABSTRACT

A computer-based technology platform with a distributed database and a uniform set of business rules is networked to money remittance transfer companies, banks, financial institutions and related entities that as unified service providers jointly create a one-system, web-based enterprise of global proportions for processing remittances. Cash management banks and clearing banks and institutions in the send and receive countries, global transaction bank for Nostro account management, payment gateway for third party processing of credit card and inter-bank settlements and Treasury Service providers for centralized global treasury services, are among the strategic alliance partners that support the system. There are ancillary service providers such as best practices companies located in every region that ensure due-diligence and compliance, enforcing strict entry barriers for service providers and customers.

### RELATED APPLICATIONS

This application claims the benefit of U.S. Provisional Application No. 60/691,032 filed Jun. 16, 2005, and is herein incorporated in its entirety by reference.

### FIELD OF THE INVENTION

The invention relates to financial service systems and more particularly, to a computer-based network of service providers connected to a common technology platform and operating under a uniform set of business rules with integral country specific and cross-national compliance provisions, to conduct a remittance service of global proportions.

### BACKGROUND OF THE INVENTION

Workers' remittances have become a major source of external development finance, providing a convenient angle from which to approach the complex migration agenda. The development community needs to consider how to best manage remittance flows and how the body of research on remittances can be strengthened, both for the purpose of understanding the impact of remittances and for forming more effective policy for managing remittances. Officially recorded remittances received by developing countries exceeded $167 billion in 2005. The actual size of remittances, including both officially recorded and unrecorded transfers through informal channels, is even larger. Remittances are now more than double the size of net official flows, and are second only to foreign direct investment as a source of external finance for developing countries. Exorbitant fees —13 percent on average and frequently as high as 20 percent—charged by money transfer agents are a drain on hard-earned remittances. These fees especially affect the poor. Reducing remittance fees by five percentage points could increase annual remittance flows to developing countries by $4 to $5 billion.

It is difficult to see why remittance fees should be so high, and why they should increase—rather than stay fixed—when the amount of transfer increases. It appears that the regulatory framework is flawed. There seem to be barriers to competition, and perhaps duplication of efforts in the payments system (e.g., each transfer agency investing in its own proprietary transfer system). Fixing this problem would involve policy coordination in both source and destination countries. Improving migrant workers' access to banking in the remittance-source countries (typically developed countries) would not only reduce costs, but also lead to financial development in many receiving countries.

There is a need to strike a balance between a regulatory regime that minimizes money laundering, terrorist financing, and general financial abuse, and one that facilitates the flow of funds between hard-working migrants and their families back home. Remitters use informal channels because these channels are cheaper, better suited to transferring funds to remote areas where formal channels do not operate, and offer the advantage of the native language and, on rare occasions, anonymity. Informal channels, however, can be subject to abuse. Strengthening the formal remittance infrastructure by offering the advantages of low cost, expanded reach, and language can shift flows from the informal to the formal sector. Both sender and recipient countries could support migrants' access to banking by providing them with identification tools.

Reliable data on remittances is a key to understand the impact of development, yet available data leave much to be desired. Informal remittances are large and indeterminate. But even recorded data are also incomplete. A major effort is necessary to improve data on remittances. This effort will have to go beyond simply collating information. It requires investigating the relationship between migration stock and remittance flows, migrant workers' remittance behavior in major remittance-source countries, and the way remittances respond to changes in the source and destination economies.

Remittance inflows for 90 developing countries amounted to about $100 billion in 2003, $126 billion in 2004, according to International Monetary Fund (IMF). Officially recorded remittances world wide is $167 billion in 2005. The global payment industry is witnessing the entry of credit unions and clearing houses and is no longer confined to the traditional players like Banks, Financial Institutions and Individual Money Transfer Operators (MTOs), who are focused on single and specific corridors (e.g. US to Vietnam). Remittances to South Asia continue to grow at 15-18% per annum for the next several years, according to various analyst estimates. India has emerged as the highest remittance receiving country in the world at $21.7 billion in 2005.

Remittances are primarily from migrant individuals and/or households with the industry witnessing over 20% annual growth in migration of workforce from underdeveloped to developed countries. Remittances are small and frequent providing support to the aging ethnic population residing in the receiving areas. Electronic Money Transfer (EMT) is poised to grow faster than the paper-based remittance. IT innovations like SWIFT networks and payment gateways have led to the breakup of traditional value chains resulting in the integration of payments into new transaction and supply chains. Outside of Western Union and Money Gram, most of the other players are small, less than $5.0 million in revenues, one exception being UAE Exchange, largely confined to a specific country or region pair e.g., US to Bangladesh, GCC to India, etc.

Most industry players use the traditional independent agent distribution model across all send geographies, which is located in certain areas and is time-consuming to access. Most players including Western Union and Money Gram do not offer a comprehensive product to adequately address the needs of South Asian communities across key send and receive markets. What is need is an offering of multi-mode products like Cash, Cheque, Drafts, Online transfers, etc., on the same platform, giving the flexibility to the end users to choose.

Western Union and Money Gram provide premium product pricing thus creating a need for a low cost, high quality provider. According to IMF study on remittances, remittance cost can often exceed 20 percent when transmission fees and exchange rate cost are both factored in. With the exception of Western Union and Money Gram none of the other players have dedicated customer or agent service call centers thus creating a further need to elevate the level of service to both customers and agents. The industry is presently characterized by high operating margins, up to 20% for most of the corridors. High operating margins of big MTO's suggests a need for competitors to introduce services with significant reductions in transaction fees.

These and other and significant short comings and problems with the presently available enterprises and their systems and processes are readily apparent to those skilled in this field. The requisite scale of an improved process for serving this need and solving some of these problems is global.

### SUMMARY OF THE INVENTION

The invention is broadly referred to herein as a SIAMR (Safe Instant Affordable Money Remittance) system and process. The applicant may have trademark rights in the term SIAMR. The invention may be further characterized as a global ‘remittances—marketplace’ and payment platform where service providers that may include money remittance transfer companies, banks, financial institutions and related entities jointly create a web-based marketplace supported by strategic alliance partners. Cash management banks and clearing banks and institutions in the send and receive countries, global transaction bank for Nostro account management, payment gateway for third party processing of credit card and inter-bank settlements and Treasury Service providers for centralized global treasury services, are among the strategic alliance partners that may support the service providers and comprise the SIAMR system and process.

In addition to these, SIAMR may be supported by other ancillary service providers such as Best Practices Companies and Call Center. Best Practices Companies (BPC) are located in different geo/political region and ensure due-diligence and compliance, enforcing strict entry barriers for Service Providers and Customers joining the SIAMR marketplace. SIAMR marketplace is typically supported by a multi-lingual Call Center in every region. Agents, Customers, Strategic Alliance Partners and other SIAMR participants provide support via respective Call Centers. Broadly stated, SIAMR is a comprehensive global payment marketplace formed by a send and receive distribution network and supported by highly competent strategic alliance partners.

In one aspect, the invention is a distributed remittance system for transferring monetary payments among users where the users consist of senders intending to make remittances and beneficiaries designated by the senders to receive remittances. It consists of multiple service providers networked together by a common, computer-based technology platform to perform remittance services for said users. The service providers include sending agents accessible by the senders for placing remittance orders, and receiving agents having access to the beneficiaries for completing the remittance orders. The technology platform consists of a distributed computer database and a shared set of integral business rules defining selected parameters for compliance checks of all remittance orders, processes by which the remittance orders may be electronically executed, and an electronic funds transfer gateway for accessing third parties for fund transfers. A remittance order is a tender of payment by a sender from at least one monetary source owned or controlled by the sender, and may be hard currency or government-backed currency of any country, negotiable instruments such as checks, drafts and so on, or electronically accessible monetary accounts in banks or elsewhere as might be represented by a debit card, or from lines of credit such as might be represented by a credit card.

The system uses web based access for users and/or agents, and offers electronic forms by which the users may be registered and their remittance orders may be entered into the system. Of course, this can also be done manually on paper forms and then be scanned or transcribed by an agent for submission to the system. The forms include sections for identifying at least one unique beneficiary to receive the remittance, and means for identifying the exact monetary source for the tender of payment, meaning that the sender has authorized the system directly or through its agent to access this source of funds in the amount stipulated.

The uniform set of business rules by which the system operates, incorporates compliance checks for adding new service providers to the system, as well as having compliance checks for candidate senders, beneficiaries, and their respective remittance transactions, which are conducted prior to final approval and execution of each proposed remittance transactions. The business rules also incorporate compliance checks for country-specific regulations affecting users and remittance transactions, which again are done prior to final approval and execution of each remittance transaction. There are also compliance checks for cross-national regulations affecting users and remittance transactions that cross national boundaries, which are made prior to final approval and execution of each remittance transaction.

In another aspect, the service providers include or are further supported by strategic alliance partners and ancillary service providers. The strategic alliance partners consist of cash management banks networked to the system by the common, computer-based technology platform, where each sending agent is associated with at least one cash management bank, each receiving agent is associated with at least one cash management bank, each cash management bank is configured for pooling and reporting on the payments received from its respective sending agents and senders, and sent to its receiving agents and respective beneficiaries, all in accordance with the system wide business rules.

In another aspect of the invention, strategic alliance partners include at least one global transaction bank networked to the system by the common, computer-based technology platform, and is configured for processing cross-national fund transfers between the cash management banks in accordance with the business rules of the system. There may be a global treasury service associated with the global translational bank and configured for monitoring multiple country currency levels in system accounts and adjusting balances so as to manage risks to the system and enterprise relating to a dynamic foreign exchange market.

In yet another aspect, sending agents may also be receiving agents and may be money remittance transfer companies, banks, and financial institutions functioning as agents.

In still another aspect of the invention, ancillary service providers may include a best practices company networked to the system by the common, computer-based technology platform and configured for processing selected business rules relating to certain compliance checks and reporting compliance status to the system.

In yet another aspect, the invention may be embodied in a computer-enabled method using the system described, where an online form for sender registration is completed electronically and submitted to the system for approval; selected compliance checks are automatically conducted within the system on the sender in accordance with the business rules, whereupon when approved, an indication of acceptance is issued; an online form is then completed for a remittance order, identifying a beneficiary and identifying an amount and a monetary source for funds for the remittance, and submitted to the system for execution; selected compliance checks of the sender, beneficiary, and the remittance order are conducted within the system in accordance with the business rules; whereon the compliance checks are all completed, transferring funds from the identified monetary source to the system; and then transferring the funds from the system to the beneficiary.

The business rules for such a method may require compliance checks for candidate senders, beneficiaries, and remittance transactions, made prior to final approval and execution of the remittance transactions; compliance checks for country-specific regulations affecting users and remittance transactions, made prior to final approval and execution of remittance transactions; and compliance checks for cross-national regulations affecting users and remittance transactions extending from one country to another, made prior to final approval and execution of a remittance transaction.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a system diagram overview of one embodiment of a SIAMR system and process, illustrating the major classes of participants and their respective channels of interaction across a web-based, global technology platform.

FIG. 2 is a diagram showing the representative subgroups of sending agents, receiving agents, money remittance transfer companies, and other end user-accessible financial entities participating in the SIAMR marketplace that fall within the Service Provider category of SIAMR participants.

FIG. 3 is a diagram illustrating typical processes undertaken by a Service Provider in one embodiment of a SIAMR system and process.

FIG. 4 is a diagram illustrating a typical process of compliance checks undertaken by a Best Practices Company in one embodiment of a SIAMR system and process.

FIG. 5 is a diagram illustrating functional modules of the computer-based technology platform shared by the networks SIAMR participants.

FIG. 6A is a diagrammatic illustration of the technology platform compliance architecture illustrating the tiered local, national, and cross-national compliance checks that are integrated into the processing of each remittance.

FIG. 6B is a diagrammatic flow chart of processes relating to the compliance functions of SIAMR.

FIG. 7 is a diagrammatic flow chart of processes relating to the adding of new strategic alliance partners to SAIMR.

FIG. 8 is a diagrammatic flow chart of a process for admitting a new agent into SIAMR.

FIG. 9 is a diagrammatic flow chart of processes by which ancillary service providers are added to SIAMR.

FIG. 10 is an illustration of a screen shot of an online application for registration of a user of SIAMR.

FIG. 11 is an illustration of a screen shot of an online application for a remittance order.

FIG. 12 is a diagrammatic illustration of processes occurring between a CMB and the SIAMR system via its network connections to the SIAMR technology platform.

FIG. 13 is a diagrammatic illustration of processes occurring between a global transaction bank and the SIAMR system via its network connection to the SIAMR technology platform.

FIG. 14 is a diagrammatic illustration of processes occurring between a global treasury services entity and the SIAMR system via its network connection to the SIAMR technology platform.

FIG. 15 is a diagrammatic flow chart illustrating the process by which an online remittance order submitted by a user is executed in the SIAMR system.

FIG. 16 is a diagrammatic flow chart illustrating the process by which a remittance order submitted by a user to an SIAMR agent is executed in the SIAMR system.

FIG. 17 is a diagrammatic flow chart of subprocesses occurring within the SIAMR system for execution of a remittance order.

FIG. 18 is a diagrammatic flow chart illustrating compliance checks occurring within the SIAMR system relating to a remittance order.

FIG. 19 is a diagrammatic flow chart of a receiving end process in SIAMR relating to a remittance order.

FIG. 20 is a diagrammatic flow chart illustrating the due diligence checks of a proposed beneficiary occurring in SIAMR prior to approval of a remittance order.

FIG. 21 is a diagrammatic flow chart of a process occurring within SIAMR relating to a settlement request by an agent after a remittance order is completed.

FIG. 22 is a diagrammatic flow chart of a process occurring within SIAMR relating to foreign exchange transaction flow.

### DETAILED DESCRIPTION

The invention is susceptible of a range of embodiments and variations. What is described and illustrated in the figures are merely exemplary embodiments of what is claimed below. Proffered acronyms in Table 1 and elsewhere in the text may appear in singular or plural form and mean either or both, and may refer to or mean an operating entity or the service it provides, so far as the context admits. The terms Users and customers are used interchangeably, and both refer to either or both remitters and recipients, which may also be variously referred to as payors and payees or senders and beneficiaries.

TABLE 1
Selected Acronyms and Definitions

| Terms | Description |
|---|---|
| SIAMR | Acronym for the Remittance System Invention |
| | (Safe Instant Affordable Money Remittance) |
| SP | Service Provider |
| SAP | Strategic Alliance Partner |
| CMB | Cash Management Bank |
| GTB | Global Transaction Bank |
| GTS | Global Treasury Services |
| MLRO | Money Laundering Regulatory Officer |
| OFAC | Office of Foreign Assets Control |
| US PATRIOT ACT | Uniting and Strengthening America by Providing |
| | Appropriate Tools Required to Intercept and |
| | Obstruct Terrorism ACT |
| BSA | Bank Secrecy Act |
| FATE | Financial Action Task Force |
| CMS | Customer Management System |
| SMS | Security Management System |
| BPC | Best Practices Company |
| Nostro Account | A banking term to describe an account one bank |
| | holds with a bank in a foreign country, usually in |
| | the currency of that foreign country |
| GA | General Administrator |
| MA | Master Administrator |
| Info | Information |

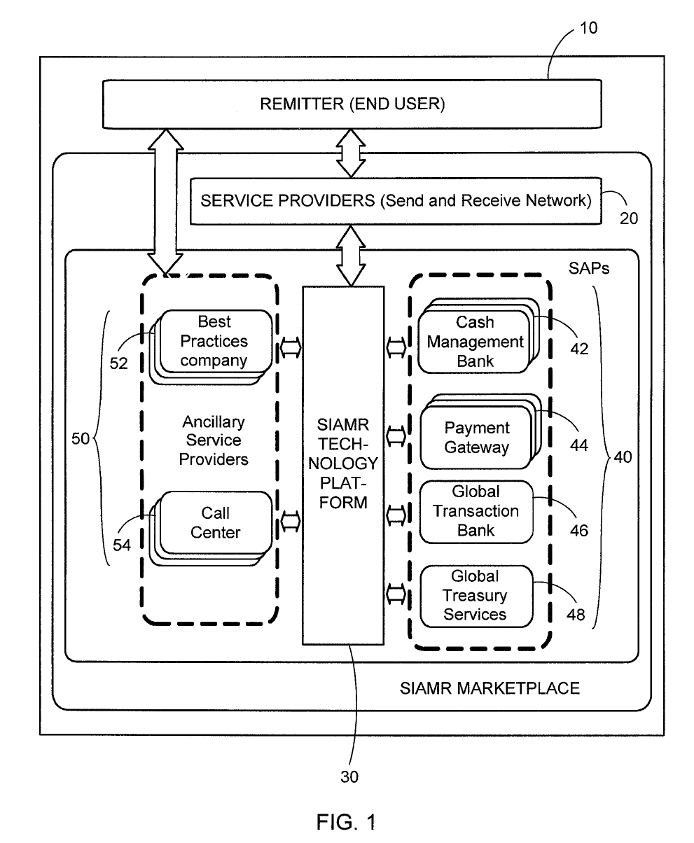

Referring to FIG. 1, the SIAMR system and process is a web-based enterprise application with in-built business processes and transaction processing capabilities. Users includes remitters and recipients that interact with Service Providers 20, that via the SIAMR Technology Platform 30 interconnect Strategic Alliance Partnerships 40 and Ancillary Service Providers 50 to provide efficient, secure services on a global scale. SIAMR offers secure online payment options through payment gateways, allowing third party validation of credit card and bank debits for electronic fund transfers. The powerful, current embodiment, technology platform 30 supporting SIAMR has been built on Microsoft's .net technologies with Microsoft SQL Server 2000 at the backend. SIAMR's architecture is web-enabled and service oriented to allow easy web service integration with its partners' systems. The invention anticipates and includes further advances and upgrades in the core technology platform and the software and hardware components used by the various system participants, including the users, for distributed access, security, data processing and communications functions and processes enabled by technology platform 30.

SIAMR is adaptable to incorporate full regulatory compliance for the states and regions within which it operates, such as the US Patriot Act, anti-money laundering rules and BSA/FATF guidelines for the United States. It is compatible with multiple delivery options, including for example direct deposit, home delivery, demand draft and cash pick-up. It is also user friendly and has robust reporting capabilities. The system can also be used for online transaction origination using a credit card, debit card, etc, as well as agent interaction with checks, drafts and negotiable instruments generally. In summary, it offers multiple modes of transaction offering the user high levels of flexibility and ease of access as remitter or recipient on a local and regional basis in a system of global proportions.

Still referring to FIG. 1, SIAMR functions as a marketplace where market participants with appropriate core competences, market experience and penetration, form Strategic Alliance Partnerships 40 and operate as components of SIAMR. The strategic alliance partners offer competitive services to the marketplace through inbuilt business processes in their domain of expertise. These associations also ensure low variable costs, low operating expenses as individual relationships with Banks and Clearing Houses are not required for settlements and reconciliations, thereby ensuring an affordable product offering for the end user customers.

Again referring to FIG. 1, Strategic Alliance Partners 40 of SIAMR include several subgroups. Clearing/Cash Management Banks 42 (CMBs) are banks that maintain the account where the funds received for remittance are pooled and collected in the “send” countries and also the account where funds are provided for payments in the “destination” countries. CMBs ensure instant settlements and reimbursements in send-side/host countries. Global Transaction Banks 46 (GTB) are banks where SIAMR maintains an account and the account is used for settling transactions with the CMBs 42. A Global Transaction Bank facilitates cross country settlements. GTBs deal in foreign exchange as advised by Global Treasury Services 48. Global Treasury Services 48 (GTS), create deals and send instructions to GTBs 46 for foreign exchange trading. GTS monitor the currency exposure of SIAMR dealings by accessing Exposure Reports occurring in SIAMR. Payment Gateways 44 are used for third party processing of credit card and inter-bank settlements.

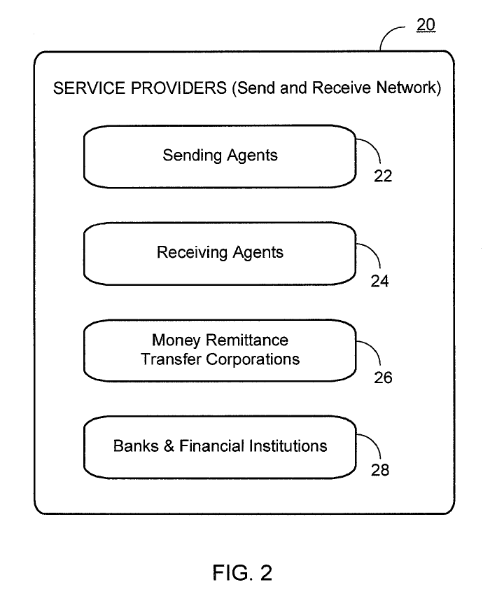

Service Providers 20 (SP) include several subgroups as well. Referring to FIG. 2, there are Sending Agents 22, Receiving Agents 24, Money Remittance Transfer Companies 26, and other end user-accessible Banks and Financial Institutions 28 participating in the SIAMR marketplace. Sending Agents 22 are basically agents collecting money from customers for the purpose of remittance to different countries or locations. Their primary functions are to collect money on behalf of SIAMR and settle with SIAMR. Receiving Agents 24 are responsible for paying out the remitted money to the beneficiaries or Recipients in the destination country/location. Money Remittance Transfer Companies 26 are basic money remittance agencies with large retail networks, credit unions, post offices, and other end user-interface facilities which perform the functions and provide the services of a sending and/or receiving agent. Bank and Financial Institutions 28 also tie up with SIAMR so as to form a correspondent network and perform the functions of a sending and/or receiving agent on behalf of SIAMR.

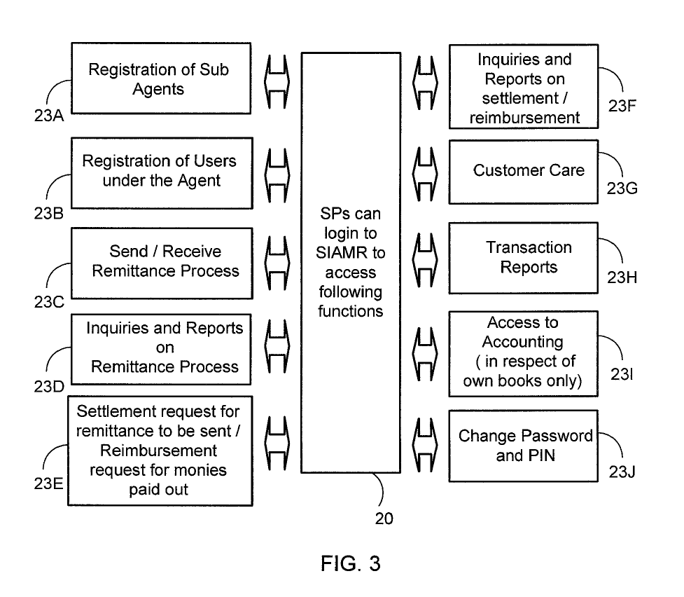

Referring to FIG. 3, Service Providers 20 of FIG. 1 interact with SIAMR to accomplish the Service Provider Processes 23 including: registration of Sub-Agents 23A; registration of users for the Agent's sub-system 23B; sending and receiving remittances 23C; processing inquiries and reports on Remittances 23D; processing settlement and reimbursement requests 23E; generating inquiries and reports on settlements and reimbursements 23F; providing miscellaneous and general customer care to Users 23G; generating transaction reports 23H, providing access for auditing of internal records 231 for compliance with SIAMR system rules; and providing for changing of passwords and personal identification numbers (pin) 23J.

Referring again to FIG. 1, Ancillary Service Providers 50 (ASP) include Best Practices Companies 52 (BSP) and Call Centers 54 (CC). The ancillary service providers 50 are regionally based to provide local support to Users 10, SPs 20, and SAPs 40.

Best Practices Companies 52 perform all necessary due-diligence, compliance and regulatory checks before qualifying new SPs, SAPs and customers to be added to SIAMR. BSP's comply with all the international and local regulations before addition of any of these categories of SIAMR participants. For example, if a new Service Provider needs to be qualified, the BPC will confirm trade license and other requirements for service providers of that type in the respective jurisdiction or state.

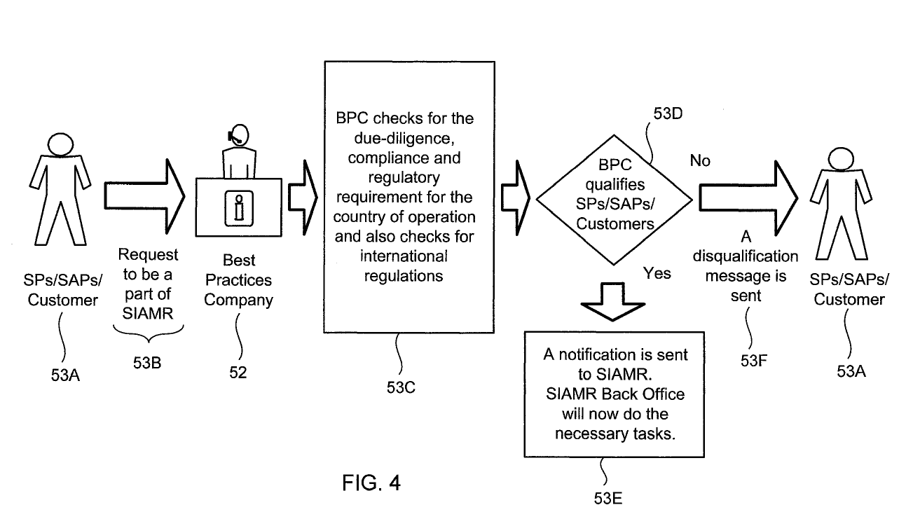

Referring now to FIG. 4, a typical process 53 of a Best Practice Company 52 is illustrated. Applicant 53A, which may be an applying to be a SIAMR participant including any of SP, SAP, or customer, submits a request 53B which is received by a Best Practice Company 52 and evaluated 53C for compliance with SIAMR, local and international rules and regulations. A decision 53D yields an acceptance 53E distributed to the SIAMR community or a denial 53F communicated to the Applicant.

Regional Call Centers 54 of FIG. 1, which may have multilingual capabilities appropriate to their regions, route inquiries and other communications between customers and other SIAMR participants including SPs and SAPs. A Customer Management System (CMS) and Process is a function of Call Centers 54. A CMS program is available to all Call Center support staff as the mechanism and procedure by which they service and link the customer(s), SPs and SAPs of SIAMR. The call center executives have access to CMS. Each regional Call Center 54 is a single point of contact for all kinds of queries and requests for SIAMR.

Within the Call Center 54 structure and process, Support Executives have a unique login ID to the system and have limited access to the SIAMR data; for example, only transaction data can be read by the Support Executives but no changes can be made to it. Support Executives are available for any sort of assistance to SIAMR Customer(s), SPs and SAPs. Each Request attended by Call Center Support Executives is logged in the SIAMR system. Each Request is assigned a unique Request ID or identifier, typically an alpha/numeric designator that is easily digitized for computer processing. The full designator may be unique throughout the SIAMR system for unambiguous tracking of the Request. The request ID may also be given to the Customer/Agent calling to SIAMR Support Executive. The records are archived, so that SIAMR may later use the ID reference number to identify who handled the call and what kind of support was given to person calling for assistance, for purposes of quality control or resolving later discovered errors or malfeasance.

The End Users 10 of SIAMR are categorized into two types—Online Users and Users through Service Providers 20. An Online User is a user of the SIAMR system who accesses the SIAMR system directly, such as by a browser-based access to an internet website on a global computer network, bypassing the SIAMR Service Provider, and performs an online money remittance transaction. An Online User, once registered and recognized by SIAMR, can perform an online, electronic transaction such as by using a credit/debit card or through-bank transfer linked to his previously established account at an electronically-accessible financial institution. Such a transaction might involve a log-on to an SIAMR site, registration or verification of prior registration, entering sufficient recipient or payee data to record the payee in the SIAMR system, selecting a sending mode/source for the payment, selecting a payment or receiving mode, such as by electronic deposit to a specific account or bank check, or notice to apply in person or online for the payment at a specific facility or financial institution or online point of access. The SIAMR system will do the background compliance checks for system, local and international regulations in a transparent manner, and execute the transaction if appropriate.

For example, the steps for online User interaction with SIAMR might be as follows: a new online user first registers with SIAMR & receives a login ID and password for his or her or its account. A registered user can login to his account using his login ID and password. The User selects a beneficiary from his past transactions and lists of beneficiaries, or adds a new beneficiary to whom he will remit money. The User selects the sending mode of payment—e.g. credit/debit card or bank transfer. The User selects the receiving mode of payment—e.g. cash/bank transfer or direct deposit. SIAMR in a totally transparent back end process checks with the compliance and regulatory rules. If the transaction is suspicious, a SIAMR Compliance Officer is notified and takes necessary action such as to inhibit the transaction, preserve evidence of the attempted transaction, and report to the appropriate government authorities. Of course, if the transaction is not flagged as suspicious, processing is continued until the transaction is completed by a Sending Agent 24, the system is updated, and the payer/User is notified accordingly. Notification may be in the form of an assumed successful completion, with actual notification occurring only on an exception basis where there is a failure or delay of the transaction for any reason, such as insufficient funds being available from the payor's designated source of funds, an unavailable or unresponsive beneficiary, or a regulatory issue with the requested transaction.

Alternatively, Users 10 of FIG. 1 can approach an SIAMR Service Provider 20 with a request to remit money to a particular destination. Service Provider 20 logs into its SIAMR account through its web-based interface and performs the remittance transaction according to the same general rules that apply for the online User. Receiving Agents 24 of FIG. 2, tasked to complete the transaction also log into their SIAMR account and access the list of beneficiaries and the designated beneficiary(s) to be reimbursed. Receiving Agent 24 pays out to the beneficiary after checking the beneficiary's identity as specified by the SIAMR system rules, and records the completion of the transaction within SIAMR system records.

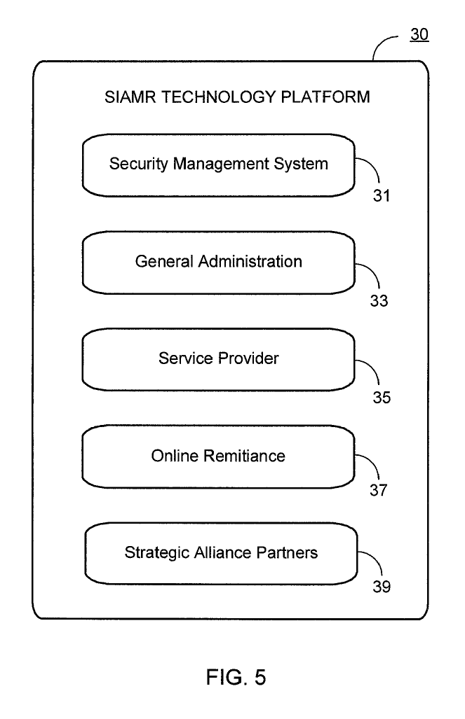

Referring to FIG. 5, the SIAMR Technology Platform 30 and process flow for this embodiment are described. The technology may be embodied in central and/or distributed system of hardware, software and computer databases, such as in a network of computers linked by direct or web based wired and/or wireless means, configured with multiple points of direct and web based user access and interface, further configured to accept manual and automated inputs of security controls, business rules and fund transfer requests, to process electronic funds transfers in accordance with comprehensive business rules, and to archive and output appropriate reports. There are separate modules for component functions of the platform. These may include a Security Management System Module 31 (SMS), General Administration Module 33, Service Providers Module 35; Online Remittance Module 37 and Strategic Alliance Partners Module 39

Still referring to FIG. 5, the SMS Module 31 is a limited access module with tiered levels of local or online access. Individual participants must be pre-registered and have a suitable password and PIN set for access to their respective level of system access and control. Tiered levels or subsections of Module 31 access and control that may include, for example, Master Control level, General Control level, and limited or local control levels such as specific Business Master levels and other subsections with respectively lesser or more restricted access and control than full global access and control. Steps for Login to Module 31 for Master Control, for example, may require a Master Controller to enter a user ID and Password #1; whereafter the system authenticates the user. On successful login the Master Controller is asked for Password #2 and a PIN. The system authenticates the credentials entered by the Master Controller, whereupon the Master Controller has access to Master Control, General Control and all Limited Control or Business Master levels. On failure, the system asks the candidate Master Controller to re-enter his credentials. Successive failures would indicate a suspect attempt, and would cause cancellation and reporting of the attempted access.

In one embodiment, the Master Control section of SMS Module 31 consists of two sub-sections; Security Setup and Access Control. The Security Setup section is about management of Master Administrators' security profiles including personal profile, passwords, pins, and so on. The Access Control section assigns different levels of access control that a Master level administrator can have in the SIAMR system.

The Security Setup section is further divided into three components or functionalities; a Profile Management section, Change Password section; and Change PIN section. A Master level administrator can manage his own profile. For example, a Master administrator can change his contact details, personal information, etc. in this section. In the Change Password section a Master level administrator can manage his own passwords. Likewise, in the Change PIN section, a Master level can manage his PIN.

Still referring to FIG. 5, in the same embodiment, the General Control section of SMS module 31 consists of two sub-sections; the Security Setup subsection and a Roles and Responsibilities subsection. The Security Setup section is at this level about management of security profiles including password and PIN of executive and high management positions such as MD, CEO, CIO, Treasurer, Senior Administrator, etc., in the SIAMR organization. The Master administrator can monitor and manage profiles, passwords and PINs of all users. The Roles and Responsibilities section is where assignment of responsibilities for these different roles are controlled, and is likewise accessible by the Master administrator to monitor, manage, and create new Roles and Responsibilities within the system.

Also in this embodiment, a Business Master section of SMS module 31 consists of two sub-sections; Policy and Procedures, and Business Rules sections. The Policy and Procedures section contains operating rules such as the requirement for a Senior Administrator to review and approve all Agent records. The Business Rules section contains all the business rules associated with the SIAMR system. All the modules of SIAMR conform to or follow the business rules as defined in this section.

The Policy and Procedures section is further divided into four areas. There is a User Creation area where all the policies and procedures associated with creation of new users of SIAMR are defined. For example, the policies and procedures defined in this section control the creation of a new User 10 in the system. There is an Agent Creation area where the policies and procedures associated with and controlling the creation of a new FIG. 2, Agent 22 or 24 of SIAMR. There is an Authorization section where all policies and procedures associated with authorization of a fund transfer are defined. For example, a settlement/reimbursement request needs to be authorized by a treasurer, etc. And there is an Accounting area where the policies and procedures associated with the accounting module of SIAMR system are defined.

Still referring to FIG. 5, in another aspect of the SIAMR technology platform and system relating to Roles and Privileges; by using the Master Control level of access, different roles to SIAMR such as Tellers, Treasurer, and so on may be created, and privileges assigned, which define the extent of that role's access and control of information in the system. For example, using the Master Control level an authorized person logs in to SMS module 31 using his passwords and PIN. He goes to Roles and Privileges section, and adds privileges to a specific role and saves it. System users have access and control only to the extent of the privileges set in this section by a Master Controller.

In another aspect of the SIAMR technology platform and system relating to Authorization Rules, a Master Controller can set or edit all Authorization rules that need to be followed in SIAMR system. For example, a Master Controller logs in to SMS module 31 using his dual password and PIN, goes to the Authorization Rules section, adds Authorization Rules and saves them. Authorization Rules are thereby set throughout the SIAMR system and access of SIMAR users and use of the system are controlled according to the rules set by the Master Controller.

The following Table 2 illustrates various rules and sources and levels of authorization contemplated in one embodiment of SIAMR, where some rules require two levels or sources of authorization to assure system integrity.

TABLE 2
Roles, Rules and Authorizations

| | | | | | Co- |
|---|---|---|---|---|---|
| | | | Data can be | | Authorized |
| No | Rule Description | Dual* | entered by | Authorized By | By |
| 1 | Addition of CEO to | Y | Administrator | Master | Master |
| | SIAMR System | | General | Administrator | Controller |
| | | | Administrator | | |
| 2 | Addition of Super | Y | Administrator | Best Practices | General |
| | Agent | | | Company | Administrator |
| 3 | Addition of Sub-Agent | Y | Administrator | Best Practices | General |
| | | | Super Agent | Company | Administrator |
| 4 | Addition of Branch | Y | Administrator | General | Master |
| | Officer (for Super | | | Administrator | Administrator |
| | Agents) | | | | |
| 5 | Addition of Branch | Y | Administrator | General | Master |
| | Officer (for Sub | | Super Agent | Administrator | Administrator |
| | Agents) | | | | |
| 6 | Addition of Teller | N | Administrator | General | NA |
| | | | Super Agent | Administrator | |
| | | | Sub-Agent | | |
| 7 | Addition of CFO to | Y | Administrator | Master | Master |
| | SIAMR system | | General | Administrator | Controller |
| | | | Administrator | | |
| 8 | Addition of CIO to | Y | Administrator | Master | Master |
| | SIAMR system | | General | Administrator | Controller |
| | | | Administrator | | |
| 9 | Addition of MD to | Y | Administrator | Master | Master |
| | SIAMR system | | General | Administrator | Controller |
| | | | Administrator | | |
| 10 | Addition of Customer | N | Administrator | General | NA |
| | Care to SIAMR system | | | Administrator | |
| 11 | Addition of | N | Administrator | General | NA |
| | Administrator to | | General | Administrator | |
| | SIAMR system | | Administrator | | |
| 12 | Addition of Sales and | N | Administrator | General | NA |
| | Marketing to SIAMR | | | Administrator | |
| | system | | | | |
| 13 | Addition of General | Y | Master | Master | Master |
| | Administrator | | Administrator | Administrator | Controller |
| | to SIAMR system | | | | |
| 14 | Addition of Auditor | Y | Administrator | General | Master |
| | to SIAMR system | | | Administrator | Administrator |
| 15 | Addition of Product | Y | Administrator | General | Master |
| | Specialist to SIAMR | | | Administrator | Administrator |
| | system | | | | |
| 16 | Addition of Treasurer | Y | Administrator | General | Master |
| | to SIAMR system | | | Administrator | Administrator |
| 17 | Addition of Due- | Y | Administrator | General | Master |
| | Diligence Officer to | | | Administrator | Administrator |
| | SIAMR system | | | | |
| 18 | Addition of Accountant | Y | Administrator | General | Master |
| | to SIAMR system | | | Administrator | Administrator |
| 19 | Addition of JV | N | Agent | Treasurer | NA |
| | | | Accountant | | |
| 20 | Settlement | N | Agent | Treasurer | NA |
| 21 | Reimbursement | N | Agent | Treasurer | NA |
| 22 | Cancellation | N | Agent | General | NA |
| | | | Customer | Administrator | |
| 23 | FX Dealings | Y | Treasurer | General | CFO |
| | | | | Administrator | |
| 24 | Exchange Rate | Y | Administrator | General | Product |
| | Management | | | Administrator | Specialist |
| 25 | Charge Management | Y | Administrator | General | Product |
| | | | | Administrator | Specialist |
| 26 | Group Management | Y | Administrator | General | Product |
| | | | | Administrator | Specialist |
| 27 | Addition of New | Y | Accountant | Master | CFO |
| | Control Head | | | Administrator | |
| | (Accounts) | | | | |
| 28 | Addition of CMS | Y | General | Master | Master |
| | | | Administrator | Administrator | Controller |
| 29 | Addition of GTB | Y | General | Master | Master |
| | | | Administrator | Administrator | Controller |

*Needs Dual Authorization

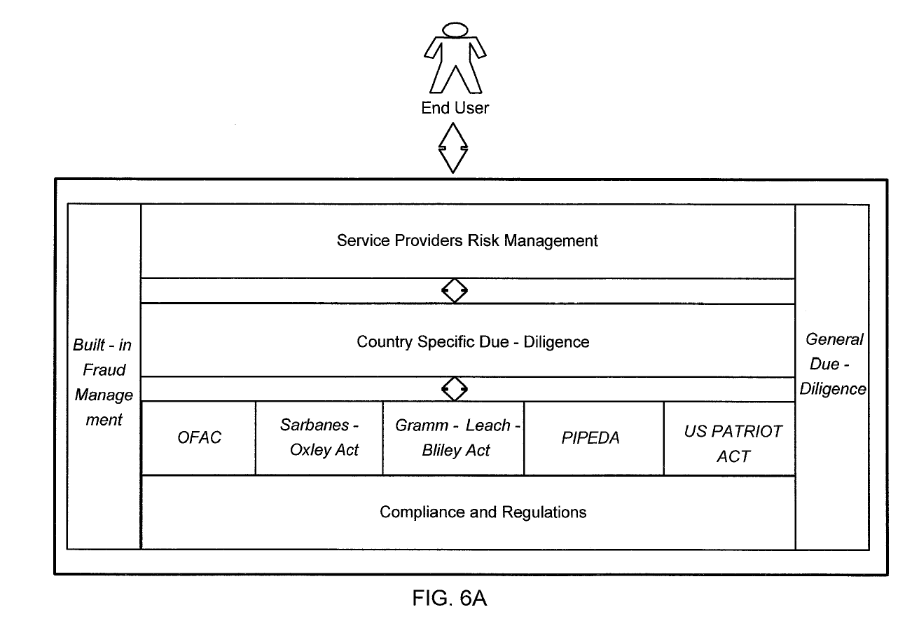

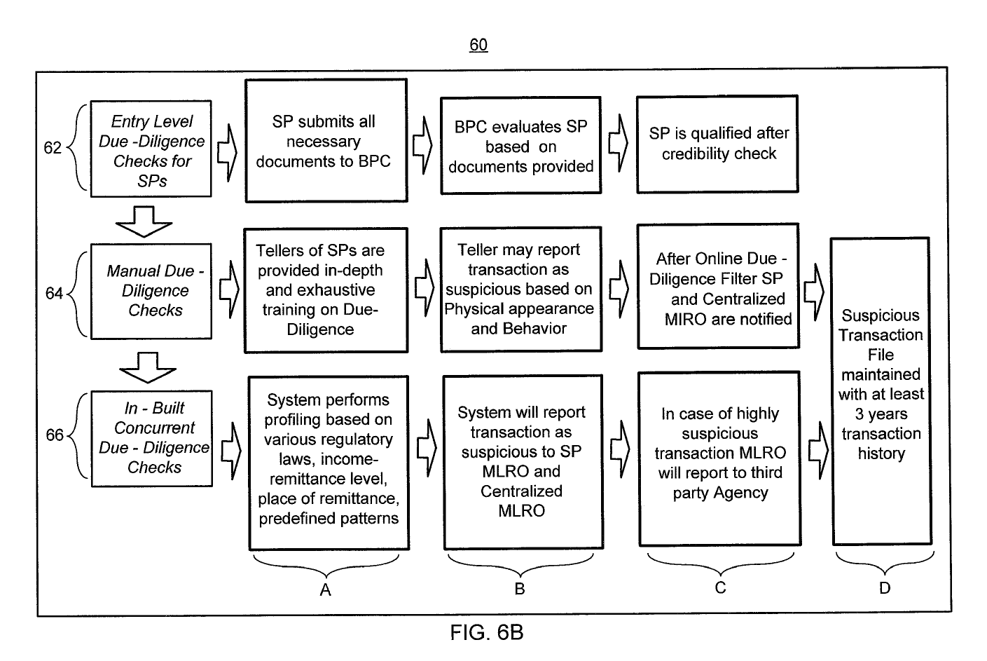

Referring now to FIGS. 6A and 6B, in another aspect of the invention regarding in particular technology platform 30 of FIG. 1 and relating to due-diligence policy of SIAMR, there is an efficiency in its compliance architecture that is derived from the significant overlap in requirements raised by many corporate, governance and privacy regulations. Due diligence and compliance checks within SIAMR are a multi-step process both vertically and horizontally, as explained below and as illustrated in FIG. 4, BPC reference 53C.

In FIG. 6B, Due-diligence and compliance checks 60 in this embodiment consist of Entry Level Due Diligence Check 62 for SPs, manual Due Diligence checks 64, and In-Built Concurrent Due-Diligence checks 66.

Entry Level Due Diligence Check 62 in the case of a candidate Service Provider for the SIAMR system, such as a remitting agent, the candidate submits 62A all necessary documents to a SIAMR Best Practice Company. The BPC evaluates 62B the candidate's application, and if appropriate, qualifies 62C the candidate for an SP role in SIAMR. The evaluation is based upon review of these documents to determine whether the applicant meets pre-determined acceptable criteria. The BPC attempts to confirm the information through third party agencies. Only if predefined objective criteria are met and confirmed, is the application accepted.

The next level of compliance checks are characterized as Manual Due Diligence Checks 64, where Tellers of qualified SPs, both Send and Receive Side, are provided 64A in-depth and exhaustive training on due diligence and compliance checks to be carried out at their respective ends of a transaction. Elements of their training may include profile training based on physical appearance and/or conduct. Tellers may then, in the course of their work, report 64B suspicious Users and transactions based on their appearance and/or behavior, to the SIAMR online Due-Diligence filter (including such as the OFAC watch list, FATF, US Treasury Department and so on) and further to the SIAMR SP's own Regulatory Officer (MLRO) for appropriate follow up. The suspicious transaction and related details are also reported to the Central SIAMR MLRO for supervisory control and auditing. SP MLRO can either block or release the transaction. However, Central SIAMR MLRO has authority to override the local SP MLRO and can block or release at his discretion. All transactions characterized as suspicious are maintained in a Suspicious Transaction File (STF) and three years history is maintained prior to off-line archival.

Still referring to FIG. 6B, the next level of compliance checks are In-built Concurrent Due Diligence Checks 62, where the SIAMR system performs profiling 66A of remitter and beneficiary, their credentials, and the proposed transaction, based on various regulatory laws, the income-remittance level, place of remittance, and other predefined thresholds, limits, and “normal” patterns. The system then reports 66B transactions that fail to satisfy the applicable checks. The system checks are crafted to comply with the requirements of such as the OFAC watch list, US Patriot Act, Sarbanes-Oxley Act, Gramm-Leach-Billey Act, PIPEDA, etc.

The responsible SP MLRO reviews transactions labeled as suspicious, and can block or release the transaction. The suspicious transaction and details are also reported to the Central SIAMR MLRO, who as described before has authority to override the local MLRO. Again, all transactions labeled suspicious are recorded in a Suspicious Transaction File (STF) for three years prior to off-line archiving; during which time the monitoring of multiple transactions over time may yield revealing patterns of potentially illegal activities not readily apparent in a single transaction. The Central SIAMR MLRO may report egregious, illegal, or otherwise seriously suspicious transactions and/or patterns of transactions to appropriate third party agencies.

Referring to FIG. 6A generally, the compliance architecture of SIAMR may be further characterized as tiered with respect to the User with a first level Service Provider's Risk Management menu, followed by a Country Specific Due-Diligence menu, and thereupon a top level internationally applicable Compliance and Regulations menu. There are concurrently structured requirements for Fraud Management and for General Due-Diligence extending through all levels of checks.

Regarding the first level Service Providers Risk Management of the Compliance Architecture, each SP has a pre-set upper limit on collected assets on behalf of SIAMR, ahead of settlements, in order to limit exposure. There are related intraday and overnight exposure limits for SPs as well. If or when the license of an SP expires, the SP is denied access to SIAMR to perform any further transaction unless it renews the license.

Regarding the next level Country Specific Due-Diligence of the Compliance Architecture, this embodiment of SIAMR, for example, incorporates licensing rules about who is allowed to send and receive remittances, including accountability to the licensing authority for the respective country. It includes rules regarding: modes of payment allowed for send/receive; remittances purposes allowed depending upon the mode of payment; limits for each mode of payment for both pay-out and pay-in; applicability of special status such as whether a SIAMR Loyalty Card Program or other such program is valid or not for the country; whether domestic payments are allowed or not allowed; restricted currencies; number of remittances that can be sent during a specified period; and the total amount that can be sent during a specified period. It includes the local aspects of such regulatory items as the OFAC Watch List, US Patriot Act and other local compliance that needs to be checked for the transaction.

Still referring to FIG. 6A, Built-in Fraud Management is a component of the Compliance Architecture concurrently operating at all levels, which provides for making checks such as: profiling User behavior to detect and prevent fraudulent activity in real time versus post transaction process detection; early identification of suspicious (Out of profile) behavior of customers automatically in real time; anticipating, adapting and predicting possible fraudulent events; detection of suspicious activity with greater accuracy; prevention of identity thefts; and making allow or deny decisions in real time during transaction processing. It may include generation of fraud log entry for each transaction, and provides for management of fraud cases organized by suspect orders, users, and individual servers from among the SIAMR community, customers, and organizations from among the SIAMR community. It may include reporting of suspicious transactions leading to a possible violation of law and regulation, deny terrorist groups access to the international financial system, provide appropriate tools to intercept money laundering incidents, and provide live updates of any new and enhanced sections of the SIAMR system anti-money laundering program.

Again in FIG. 6A, a General Due-Diligence component of the Compliance Architecture concurrently operating at all levels, provides that screening of attempted transactions can be based on either simple or complex rules. Some of the rules for exception reporting are: profiling of all the senders and beneficiary who are sending/receiving money on SIAMR; flagging transactions exceeding the normal transaction usage pattern of the remitter; flagging transactions exceeding the exposure limit for the agent; flagging frequent or other aspects of repetitive transactions between any particular remitter—receiver combination; flagging frequent or repetitive transactions where the receiver is same and the transaction is a cash transaction; flagging transactions where the beneficiary (receiver) is different from the normal beneficiaries for the remitter; flagging transactions where the beneficiary is an existing one but the destination country is different; flagging transactions to a country which is declared as non-cooperative to AML legislations; or comparing the volume of financial transactions to the size of the affected state's economy.

Finally, with respect to FIG. 6A, the final level of scrutiny is designated Compliance and Regulations and is essentially the international or cross-national component of the Compliance Architecture. It incorporates the limitations of all applicable cross-national treaties and regulations, which are well known to those in the field. Examples include the following:

Office of Foreign Assets Control (OFAC): The Office of Foreign Assets Control (OFAC) is an office of the US Department of the Treasury. OFAC is empowered by the President to administer and enforce the U.S. government's sanctions programs. These programs presently include both country sanctions, such as Cuba, Iran, and Sudan; as well sanctions placed on individual and entities whose names are place on the Specially Designated Nationals and Blocked Persons (SDN) list.

US Patriot ACT: Money Laundering Feature: The Act expands the authority of the Secretary of the Treasury to regulate the activities of U.S. financial institutions, particularly their relations with foreign individuals and entities. Some of the primary articles under this Act are as follows:

Sarbanes-Oxley Act: The Sarbanes-Oxley act was enacted by the United States Congress in July 2002. It requires publicly traded companies to ensure that they are properly reporting financial information. One of the most critical sections is section 404, which requires internal control over the creation of financial reports, and mandates responsibility for access privileges. This section is crucial for IT organizations to understand and act on.

GLB—Gramm-Leach-Bliley Act: The Gramm-Leach-Bliley act, signed in 1999, applies to financial institutions and securities firms. It requires them to implement strict regulations to protect the privacy of customer data.

PIPEDA: The Canadian Personal Information Protection and Electronics Document Act (PIPEDA), implemented in 2000, is intended to protect personal information collected over the course of conducting commerce electronically. This act governs the collection, use, retention and disclosure of personal information. It stipulates data security and limits use of personal data by corporations.

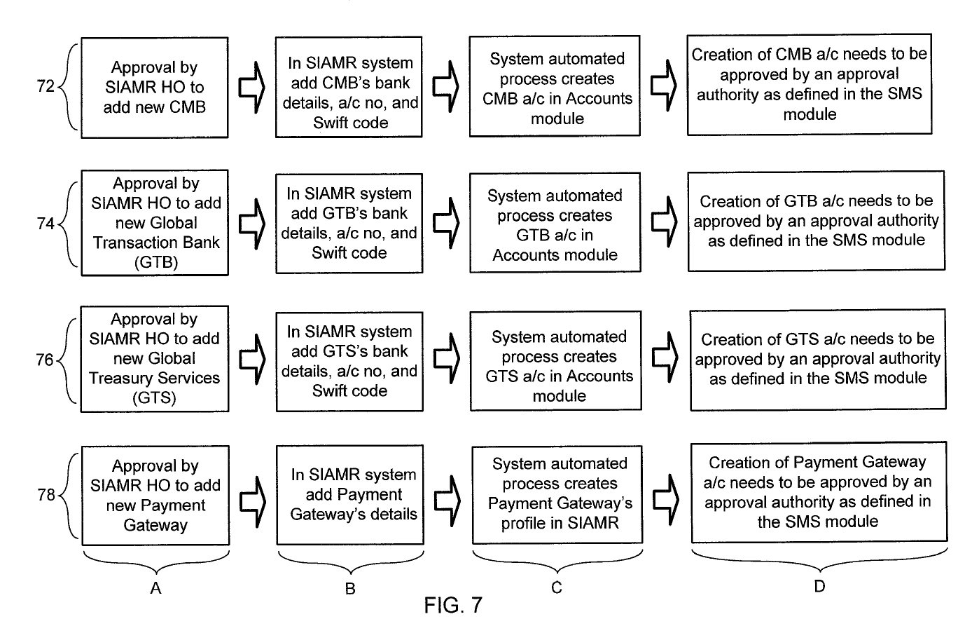

Referring now to FIG. 7, the admission of new Strategic Alliance Partners (SAP) 40 of FIG. 1 into the SIAMR community and system, first needs to be approved by the SIAMR Head Office or HO. The SIAMR HO decision to add a SAP into SIAMR is based on the past business history, financial position, services provided and service levels adhered to by the candidate SAP. For example, the process for addition of a Cash Management Bank (CMB) is illustrated at row 72 where: at 72A, the requirement has HO approval; at 72B the CMB's profile, account number and Swift code are added; at 72C the CMB info is added to the accounts module of technology platform 30 of FIG. 1; final approval 72D by SMS defined authority is required to activate the CMB within the SIAMR system.

Referring to row 74 of FIG. 7, for a candidate Global Transaction Bank GTB 46 of FIG. 1: at 74A the requirement gets HO approval; at 74B the GTB's profile account number and Swift code is added; at 74C the GTB info is added to the accounts module of technology platform 30, and final approval 74D by the SMS defined authority is required to activate the GTB within the SIAMR system.

Referring to rows 76 and 78 of FIG. 7, Global Treasury Services and Payment Gateways are added by similar processes as illustrated.

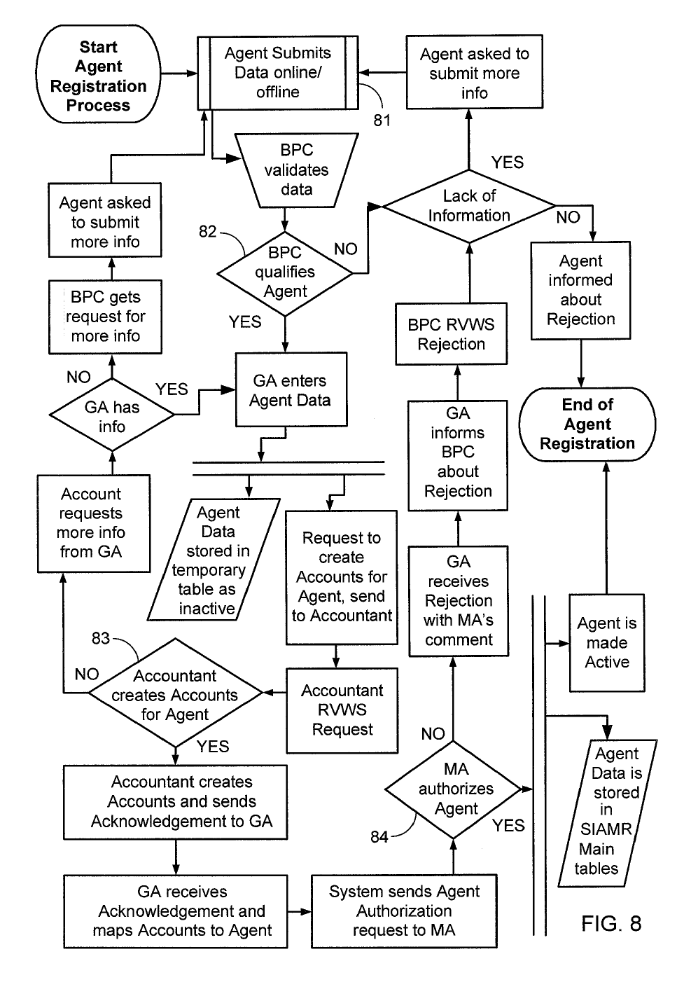

Referring to FIGS. 8-11, in another aspect of the invention, Service Providers 20 of FIG. 1 are added into the SIAMR community and system only after a stringent due diligence check is conducted by a Best Practices Company. Service Providers have to submit information and documents for verification, in this embodiment including: name and full address of the registered office of the agent; the type of agency institution—sole proprietorship, partnership, Limited Liability Company etc.; registration document for the business—registration certificate for proprietorship and partnership and the certificate of incorporation for companies; associated business documents such as partnership deeds, memorandum and articles of association as may be applicable; license or permissions for doing remittance business as applicable; offices/branches from where the remittance business will be conducted; sub agents/users data who will be part of the remittance system; infrastructure details—availability of hardware, software, people and other resources; and disclosure of associated partners forming part of the agency network and the nature of the members who will be part of agency arrangement. Candidates must further provide certification that none of the members of the agency arrangement have been involved in bankruptcy proceedings and that none of the members of the agency arrangement have felony-type convictions or other relevant criminal records.

For Agent 22 and 24 candidates, requirements include submission and review of all details of the Agent's premises including: location of the premises and information on the general area; the intended normal business hours and weekly off days; facilities and arrangements for storage of cash and valuable documents; names and contact info for bankers, type of account, account details and copies of recent bank records certified by the bankers; as well as professional and personal references with their designations, addresses, contact details such as email, telephone, etc.

Referring now to FIG. 8, the Agent Registration Process for this embodiment of SIAMR is illustrated. Steps for registration of a main or primary Agent to the system may include:

The Agent candidate submits at step 81 his details online on the SIAMR website or offline to SIAMR Head Office; the information is passed to the local Best Practices Company (BPC), who evaluates at step 82 the information provided by the candidate for adequacy and legitimacy according to SIAMR rules. If BPC needs more information, the candidate is requested to provide it. If the submission does not satisfy the required criteria, the agent candidate is informed about the rejection. If the submission satisfies the required criteria, BPC qualifies the agent and forwards the approved application to the General Administrator (GA), who directed an Accountant to at step 83 create the Agent files and enters the data into the SIAMR database. Accountant on receiving the information creates new accounts for agent, if all the required information is available to him. If all the information needed to create accounts is not available to him then he sends a message back to the GA requesting more. The GA will depending upon available information will forward the request to BPC to provide more information, which in turn will request the agent candidate to provide the information, which is then forwarded to the GA to continue the process. When the new accounts and login ID have been created by the accountant, acknowledgement is sent back to the GA who maps the accounts to the Agent. The new Agent set-up is temporary and not yet activated at this stage.

Still referring to FIG. 8, the system sends an authorization request to the Master Administrator to review the agent data and accounts and approve as step 84 or reject the request. If the Master administrator has approved the agent application and set-up, then the Agent set-up data is activated in the SIAMR main tables and the Agent is made an active as part of SIAMR network. If the Master administrator rejects the request then a message is sent to GA with the rejection reason. GA informs the BPC about the rejection. BPC checks the reason for rejection and if it is due to lack of information, it will ask agent to submit more details. Otherwise BPC will instruct GA to delete the set-up of accounts and inform the agent about the rejection.

The application and review of a sub-Agent candidate by the General Administrator is similar to that of an Agent candidate being subjected to the same principle steps of BPC evaluation, GA creation of system accounts and ID, etc., and final approval of the Master Administrator before activation, except that the sponsoring Agent is the submitter on behalf of the sub-Agent to the SIAMR evaluation process.

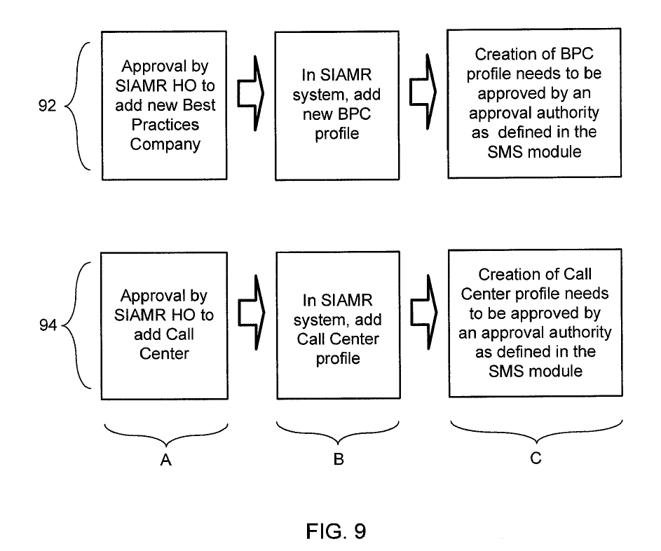

Referring now to FIG. 9, there is a requirement and provision for adding Ancillary Service Providers 50 of FIG. 1 to the SIAMR community and system as well. In one embodiment, the process for adding a Best Practices Company requires as at step 92A that the HO or head office approve the requirement and application for another BPC; and as in step 92B that the BPC profile be added to the system by a General Administrator action, and as at step 92C, final approval be obtained as defined in the SMS rules prior to activation. A new Customer Call Center candidate is processed similarly: at step 94A the requirement is recognized and the candidate approved by HO; at step 94B the system is updated with all necessary info in temporary files/tables, and at step 94C the new Call Center gets final approval according to SMS rules and is activated as part of the SIAMR community.

Having described the system and how the component entities are admitted and connected, we will describe now how candidate End Users 10 from FIG. 1 are qualified as eligible to use SIAMR. While the system is transactional in nature, it is contemplated that most users will be repeat users. It is therefore useful to register each new user with a unique system identifier and to retain initially supplied user information to facilitate future transactions, on-line transactions, and to facilitate the SMS security process and reporting requirements of the system.

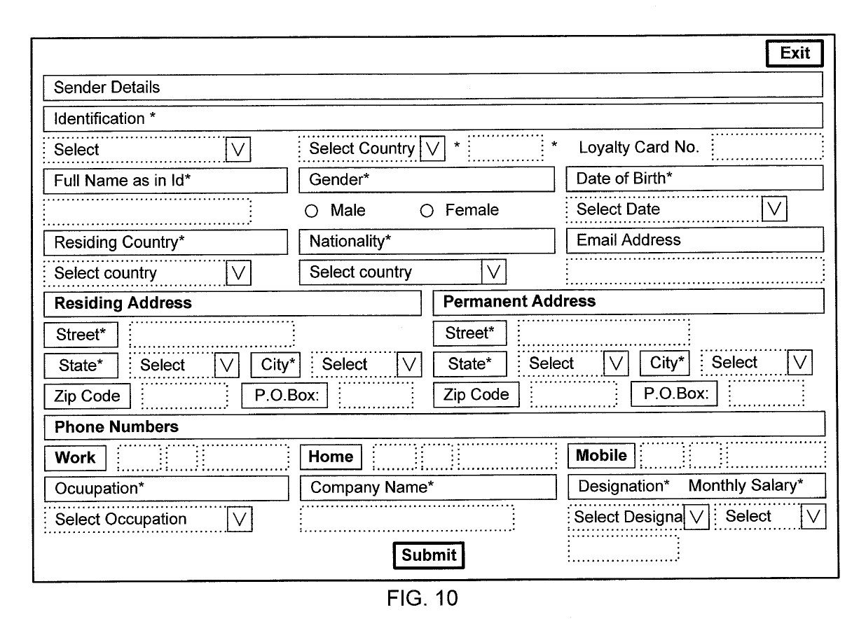

Referring to the FIG. 10 Registration Screen, the first time a sender approaches an SP for sending remittances, he or she must provide credible proof of identity—such as passport, driving license, national card or social security card, and submit an application for registration. SP then enters and submits the sender data in an on-line registration screen for which FIG. 10 is a representative example. The details provided here will be recorded in the system database, and be easily retrieved for subsequent transactions by the User or for other administrative or security purposes. Similarly the sender must submit the relevant data for each beneficiary or intended recipient, which is also stored in the system and associated with the sender.

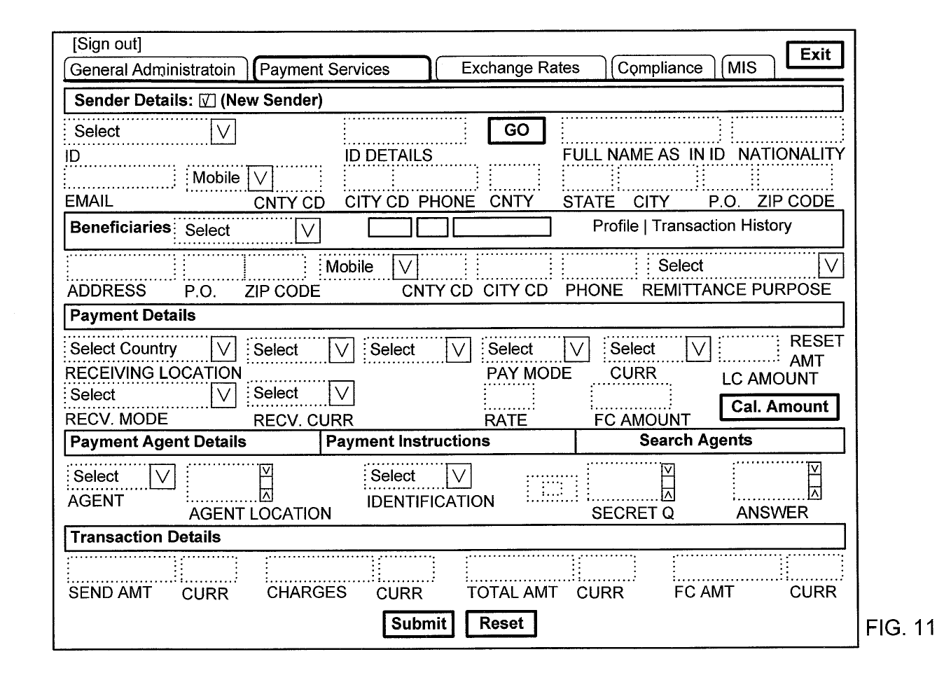

Referring now to the FIG. 11 Send Transaction Screen, a list of the sender's previously entered beneficiaries is displayed for convenient selection whenever a sender accesses the system to propose a transaction. On selecting a beneficiary from the list, all the details of the beneficiary are displayed for review, so that beneficiary details need not be entered unless their information has changed or a new beneficiary is to be designated.

For on-line User Registration bypassing a personal interaction with an SP, the User may access the FIG. 10 Registration Screen, but the submission of identity information is limited to electronic references such as bank and credit card accounts. The steps for registration of Online Users to the SIAMR system include submitting his personal and financial data via the online registration form. Online remittances are thereafter allowed, subject to SMS and other system rules and processes, but only using the credit/debit card or bank accounts that have been validated and are electronically accessible for funds transfers. The User may select from among his listed accounts for the source of the funds being remitted. Depending on the country in which the user is based and the beneficiary is located, there may be system limits for online remittance or funds transfers that reflect country or treaty provisions embodied in the system rules. These and other cross checks for restricted or fraudulent transactions will be controlled by the SIAMR system and processes as previously described.

The interaction between SIAMR and its Strategic Alliance Partners (SAP) 40 of FIG. 1 is an important aspect of the system and process.

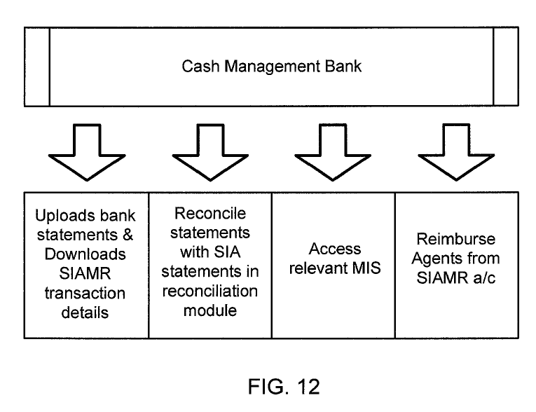

Referring to FIGS. 12, 13, and 14 respectively, Cash Management Bank 42 of FIG. 1 interacts with the SIAMR system as illustrated in FIG. 12. CMB uploads bank statements and downloads SIAMR transaction details. It reconciles its statements with SIAMR statements in a reconciliation module. It can access relevant MIS (Management Information Systems) information. It can also reimburse Agents from SIAMR accounts.

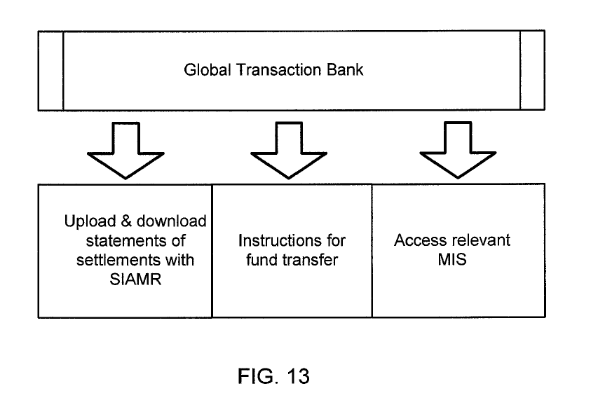

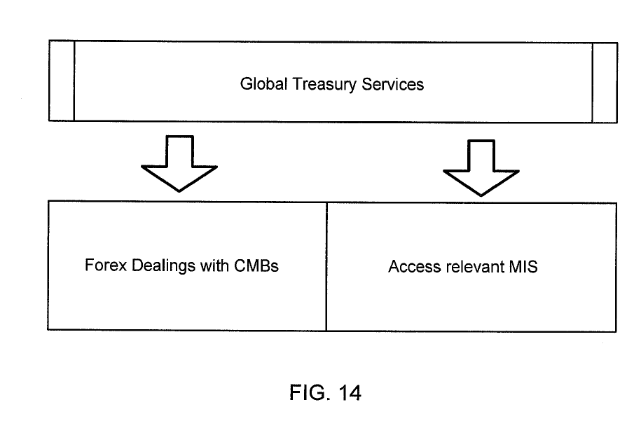

Global Transaction Banks 46 of FIG. 1 interact with the SIAMR system as illustrated in FIG. 13. GTB uploads and downloads statements of settlements with SIAMR. It accesses instructions for funds transfers from SIAMR. It can also access relevant MIS information. Similarly, Global Treasury Services 48 interacts with SIAMR to create Forex Dealings for CMBs, and can access relevant MIS information, as illustrated in FIG. 14.

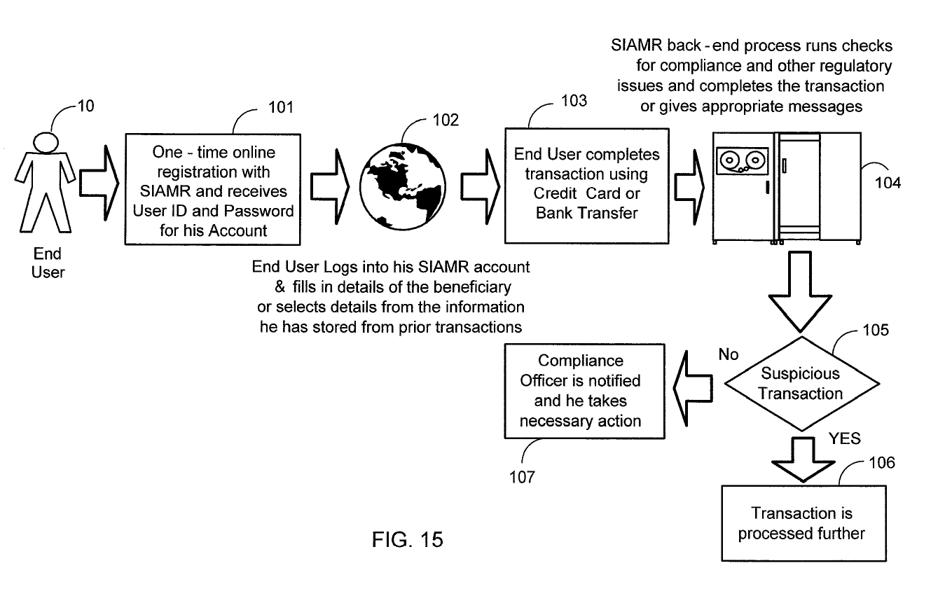

Referring now to FIG. 15, a SIAMR user has an option to send a remittance either by on-line access to SIAMR directly or though a Service Provider. Users can send remittances by bank transfer from their accounts, and from credit or debit card accounts or other electronically accessible accounts using the FIGS. 10 and 11 type on-line access and capability of SIAMR. Alternatively, these same types of electronically accessible accounts, plus hard currency, personal or bank checks and other negotiable instruments, can be used if applying to make a remittance through a Service Provider.

According to this embodiment and FIG. 15, User 10 performs a one-time online registration at 101 with SIAMR and receives User id and password for his account. User 10 logs into his SIAMR account at 102 and fills in details of the beneficiary or selects details from the information he has stored from prior transactions. User 10 then completes his end of the proposed transaction at 104 using a selected credit card or bank account or other electronically accessible funds account. SIAMR back end processes the proposed transaction at 105 for compliance and other regulatory issues and continues the transaction at 106 or reports at 107 with appropriate exception reports. For example, if the transaction is suspicious, compliance officer is notified and he takes necessary action.

It should be noted that the designated receiving parties or payees, referred to as Beneficiaries, once established in the system, may elect a default form of payment for, or form of notice of, all remittances. By prior selection or upon notice of a new remittance, the Beneficiary may select a preferred form of payment; for example, hard currency, a negotiable instrument like a check or draft, or he may designate an electronically accessible account to which the funds may be transferred by the SIAMR system.

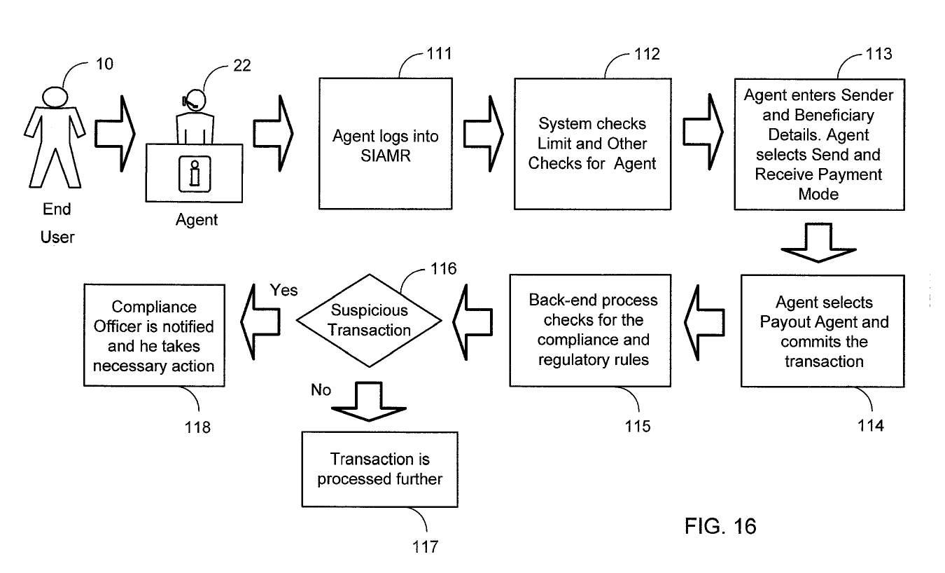

The process by which a remittance transaction unfolds through SIAMR is illustrated in FIG. 16. End User 10 approaches Agent 22 for sending remittances. Agent 22 logs into SIAMR at step 111 to access the User's account. SIAMR system runs a check at step 112 to insure that the proposed remittance is within the limit of the Agent's account. Agent 22 enters sender and beneficiary details & selects send and receive payment modes of payment at step 113. Agent selects a SIAMR payout agent and commits the transaction at step 114. The SIAMR back end process checks for compliance and other regulatory issues at step 115. The question is raised at step 116; if the transaction is suspicious, compliance officer is notified as step 118 and he takes necessary action, but if the transaction is determined to meet all SIAMR criteria and is not suspicious, transaction processing is permitted at step 117 to be continued.

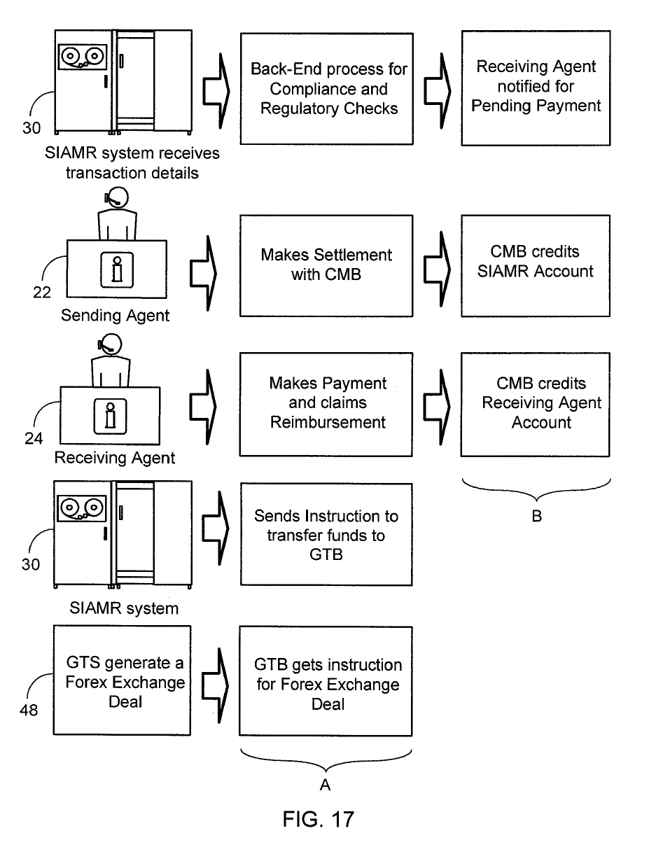

Referring now to FIG. 17, it is useful to review the SIAMR technology platform 30 and back end process for conducting the remittance transaction. On receiving transaction details, SIAMR backend process for compliance and regulatory checks is initiated at step 30A and the Receiving Agent is notified at step 30B of the pending payment. Sending Agent 22 settles with the CMB at step 22A and the CMB credits the SIAMR account at step 22B. Receiving Agent 24 makes payment to beneficiaries and claims reimbursement from SIAMR at step 24A. CMB credits the Receiving Agent 24 account at step 24B. SIAMR system 30 sends fund transfer instruction to GTB at step 30A. And GTS generates a Foreign Exchange transaction at step 48 & sends transaction instructions to GTB at step 48A.

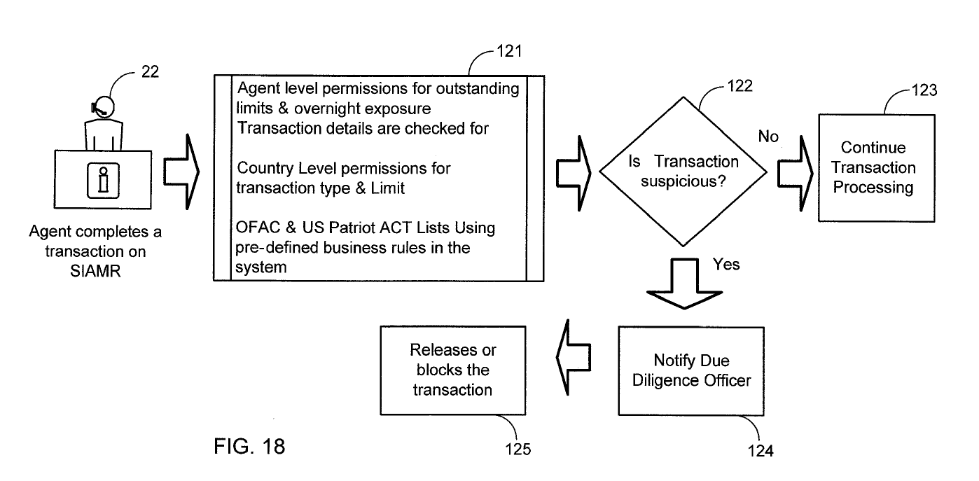

Referring now to FIG. 18, it is useful to review from the Agent's perspective, the follow-on to Agent 22's completion of application for a remittance transaction on SIAMR. SIAMR system checks the transaction details at step 121 for Country level permissions for transaction types allowed. For example, in some countries both sending & receiving remittances are allowed whereas in other countries only receiving of remittances is allowed. Some countries have limits on the amount that can be remitted for specific purposes. System rules are checked also; for example, the Agent's account has preset limits as well. Other system rules include connections to OFAC & US Patriot Act Lists for signs of fraudulent, suspicious or terrorist linked activities. The approval question is put at step 122; if the transaction is cleared by the system, transaction processing continues as step 123. If the Transaction is not cleared by the System, the system Due Diligence Officer is notified at step 124, and he reviews and blocks or releases the transaction at step 125.

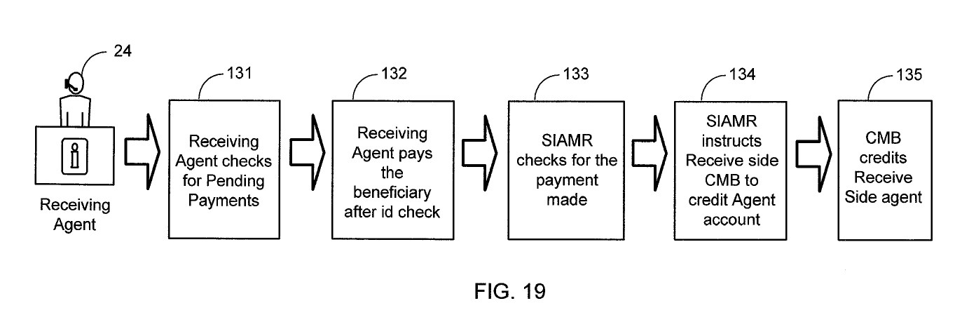

Referring now to FIG. 19, the steps for the Receive side transaction processing are as follows. SIAMR system notifies the designated Receiving Agent 24 or the agent nearest to the beneficiary, which may be an internal system posting that the Receiving Agent checks for pending payments as at step 131. The Receiving Agent 24 pays the beneficiary after checking for identity as indicated in the system, as at step 132. The Receive side Agent, through SIAMR, upon verification as at step 133 that the payment was made, notifies the Receive Side CMB to credit the agent as at step 134. Receive Side CMB then credits the Receiving Agent's account at step 135 with the payout amount. This process is normally carried out the same day, by or at the end of the day, or at a set period based on level of outstanding transactions to be processed. SIAMR MIS and call center records are updated accordingly.

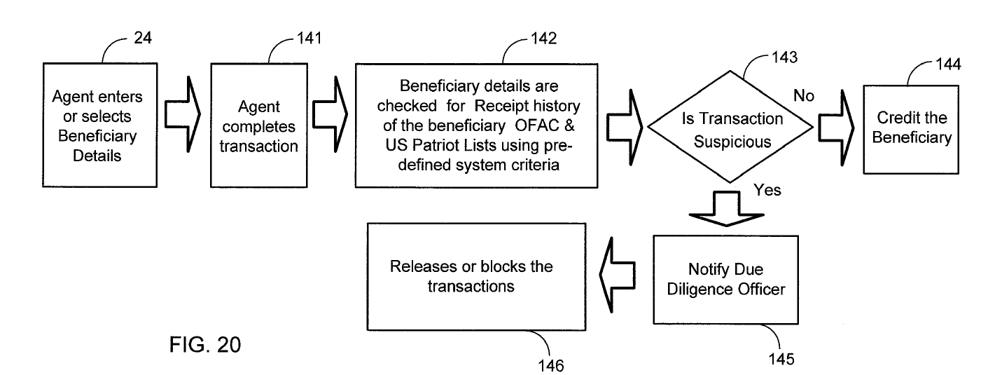

Referring now to FIG. 20, SIAMR is configured to conduct compliance and due diligence checks on the receiving side as well as on the sending side of all transactions. Beneficiaries are reviewed both with respect to their personal data and history, as well as in the context of the proposed transaction. There are several steps for the SIAMR Due Diligence checks for a selected beneficiary. The Sender or its Agent 22 sets up and/or selects a previously set up beneficiary and completes an application for remittance as at step 141. Beneficiary details are checked at step 142 for receipt history of the beneficiary and OFAC & US Patriot Lists using pre-defined system criteria. The approval question occurs at step 143; whereupon if the transaction meets the pre-established criteria, the transaction is completed at step 144. If the transaction is suspicious according to system parameters, Due Diligence officer is notified at step 145, and the Due Diligence officer studies the beneficiary transaction details and releases or blocks the transaction at step 146.

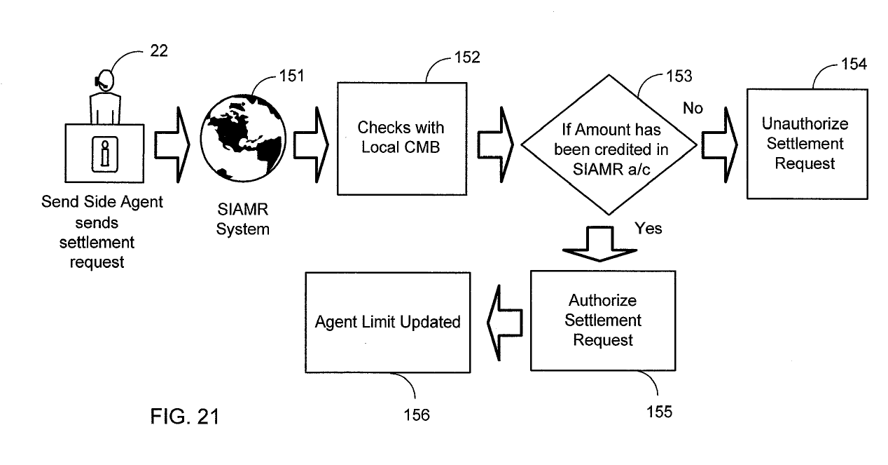

Referring now to FIG. 21, there is illustrated a settlement transaction flow from the send side agent's end. Every agent has a pre-set monetary limit in SIAMR as to the volume of open or unsettled transactions that can be pending at any time. Upon reaching the limit, the agent must settle some volume with SIAMR in order to continue to enter new transaction. This is accomplished by Send Side Agent 22 sending a settlement request for one or more transactions to SIAMR at step 151, which performs system checks 152 with local CMB as to the status of the agent's account. In answer to the question at 153 of whether or not the transaction; if the amount has been credited in SIAMR a/c, settlement request is authorized at step 155 and SIAMR system updates agent limit at step 156. If amount has not been credited in SIAMR a/c, settlement request is unauthorized at step 154.

The settlement request processing by SIAMR system through the Cash Management Bank proceeds as follows. CMB receives the settlement details from SIAMR. CMB checks if the agents have credited their SIAMR accounts in accordance with the respective settlement requests. CMB then updates the Agents' account status in the system.

Service providers such as Receiving Agents, after making a payment to beneficiary, can submit a claim for reimbursement to SIAMR. In such cases, a SIAMR officer makes a check whether the payment has been made and instructs the CMB to credit service provider's account. A Reimbursement request by a Receiving Agent is sent to SIAMR. An SIAMR officer checks if the payment has been made. If not, the request is unauthorized pending resolution. If so, an instruction is sent to CMB to credit the service provider's account. When a CMB receives an instruction from SIAMR to credit a Service Provider's account, it credits the respective account, and uploads the statement on SIAMR system.

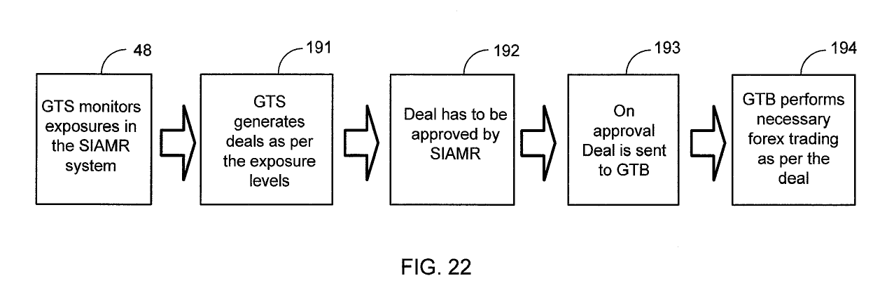

Referring now to FIG. 22, the global nature of SIAMR requires a high volume of foreign exchange dealings transaction flow. The Global Treasury Services of SIAMR will handle foreign exchange dealing along with Global Transaction Bank. Global Treasury Services has a firmware module to monitor the exposures of SIAMR and send dealing instructions to Global Transaction Bank. Foreign exchange transaction flow proceeds as follows.

Global Treasury Services 48 continuously monitors exposures of SIAMR and generates deals as at step 191, to keep SIAMR exposure at acceptable levels. Deals are reviewed and approved to SIAMR standards as at step 192 where an SIAMR Treasurer authorizes the deal, and it is then sent to GTB as at step 193. GTB receives and performs the instruction for foreign exchange and updates the system records accordingly.

The foregoing description of the embodiments of the invention has been presented for the purposes of illustration and description. It is not intended to be exhaustive or to limit the invention to the precise form disclosed. Many modifications and variations are possible in light of this disclosure, and are within the scope of or equivalent to what is claimed below, all as will be readily apparent to one skilled in the art.

What is claimed is:

1. A distributed remittance system for transferring monetary payments among users where the users comprise senders intending to make remittances and beneficiaries designated by the senders to receive remittances, comprising:
multiple service providers networked together by a common, computer-based technology platform to perform remittance services for said users;
said service providers comprising sending agents accessible by said senders for placing remittance orders, and receiving agents having access to said beneficiaries for completing said remittance orders;
said technology platform comprising a distributed computer database and a shared set of integral business rules defining selected parameters for compliance checks of all said remittance orders, processes by which said remittance orders may be electronically executed, and an electronic funds transfer gateway for accessing third parties for fund transfers;
a said remittance order comprising a tender of payment by a said sender from at least one monetary source from among the group of monetary sources consisting of government-backed currency, negotiable instruments, electronically accessible monetary accounts, and electronically accessible lines of credit;
said system comprising web based access for users and agents and electronic forms by which said users may be registered and said remittance orders may be entered into said system, said electronic forms comprising means for identifying at least one unique beneficiary for a said remittance order, and means for identifying a said monetary source for said tender of payment;
said business rules incorporating compliance checks for adding new said service providers to the system;
said business rules incorporating compliance checks for candidate senders, beneficiaries, and remittance transactions, made prior to final approval and execution of said remittance transactions;
said business rules incorporating compliance checks for country-specific regulations affecting users and remittance transactions, made prior to final approval and execution of said remittance transactions; and
said business rules incorporating compliance checks for cross-national regulations affecting users and remittance transactions, made prior to final approval and execution of said remittance transactions.

2. The distributed remittance system of claim 1:
said service providers comprising strategic alliance partners and ancillary service providers.

3. The distributed remittance system of claim 2:
said strategic alliance partners comprising cash management banks networked to the system by said common, computer-based technology platform to perform remittance services for said users, each said sending agent being associated with at least one said cash management bank, each said receiving agent being associated with at least one said cash management bank, each said cash management bank configured for pooling and reporting on said payments from its respective said sending agents and respective said senders, and to its said receiving agents and respective said beneficiaries, in accordance with said business rules.

4. The distributed remittance system of claim 3:
said strategic alliance partners comprising at least one global transaction bank networked to the system by said common, computer-based technology platform to perform remittance services for said users, said global transaction bank configured for processing cross-national fund transfers between said cash management banks in accordance with said business rules.

5. The distributed remittance system of claim 4:
said strategic alliance partners comprising a global treasury service associated with said global translational bank and configured for monitoring multiple country currency levels in system accounts and adjusting balances so as to manage risks relating to a dynamic foreign exchange market.

6. The distributed remittance system of claim 1:
at least some sending agents also being receiving agents.

7. The distributed remittance system of claim 6:
at least some of said sending agents and receiving agents comprising at least one from among the group consisting of money remittance transfer companies, banks, and financial institutions.

8. The distributed remittance system of claim 2:
said ancillary service providers comprising at least one best practices company, said best practices company being networked to the system by said common, computer-based technology platform to perform remittance services for said users, and configured for processing selected said business rules relating to said compliance checks and reporting compliance status to the system.

9. The distributed remittance system of claim 8:
said ancillary service provides comprising at least one multi-lingual call center networked to the system by said common, computer-based technology platform to perform remittance services for said users, and configured for telecommunications capability with said users, service providers, strategic alliance partners and ancillary service providers, and for processing and distribution of inquiries and answers within the system and between the system and said users.

10. The distributed remittance system of claim 1:
said technology platform comprising multi-level compliance architecture with a service provider level, a country-specific level, and a cross-national compliance and regulations level, and with concurrent fraud management and general due-diligence components extending to all levels.

11. The distributed remittance system of claim 1:
said business rules providing for agent-initiated requests for settlement, reimbursement, and account reconciliation through the system.

12. A distributed remittance system for transferring monetary payments among users where the users comprise senders intending to make remittances and beneficiaries designated by the senders to receive remittances, comprising:
service providers, strategic alliance partners and ancillary service providers networked together by a common, computer-based technology platform to perform remittance services for said users;
said service providers comprising sending agents accessible by said senders for placing remittance orders, and receiving agents having access to said beneficiaries for completing said remittance orders;
said technology platform comprising a distributed computer database and a shared set of integral business rules defining selected parameters for compliance checks of all said remittance orders, processes by which said remittance orders may be electronically executed, and an electronic funds transfer gateway for accessing third parties for fund transfers;
a said remittance order comprising a tender of payment by a said sender from at least one monetary source from among the group of monetary sources consisting of government-backed currency, negotiable instruments, electronically accessible monetary accounts, and electronically accessible lines of credit;
said system comprising web based access for users and agents and electronic forms by which said users may be registered and said remittance orders may be entered into said system, said electronic forms comprising means for identifying at least one unique beneficiary for a said remittance order, and means for identifying a said monetary source for said tender of payment;
said business rules incorporating compliance checks for adding new said service providers, strategic alliance partners and ancillary service providers to the system;
said business rules incorporating compliance checks for candidate senders, beneficiaries, and remittance transactions, made prior to final approval and execution of said remittance transactions;
said business rules incorporating compliance checks for country-specific regulations affecting users and remittance transactions, made prior to final approval and execution of said remittance transactions;
said business rules incorporating compliance checks for cross-national regulations affecting users and remittance transactions, made prior to final approval and execution of said remittance transactions;
said strategic alliance partners comprising cash management banks networked to the system by said common, computer-based technology platform to perform remittance services for said users, each said sending agent being associated with at least one said cash management bank, each said receiving agent being associated with at least one said cash management bank, each said cash management bank configured for pooling and reporting on said payments from its respective said sending agents and respective said senders, and to its said receiving agents and respective said beneficiaries, in accordance with said business rules;
said ancillary service providers comprising at least one best practices company, said best practices company being networked to the system by said common, computer-based technology platform to perform remittance services for said users, and configured for processing selected said business rules relating to said compliance checks and reporting compliance status to the system; said ancillary service provides comprising at least one multi-lingual call center networked to the system by said common, computer-based technology platform to perform remittance services for said users, and configured for telecommunications capability with said users, service providers, strategic alliance partners and ancillary service providers, and for processing and distribution of inquiries and answers within the system and between the system and said users;
said technology platform comprising a multi-level compliance architecture with a service provider level, a country-specific level, and a cross-national compliance and regulations level, and with concurrent fraud management and general due-diligence components extending to all levels; and
said business rules providing for agent-initiated requests for settlement, reimbursement, and account reconciliation through the system.

13. The distributed remittance system of claim 12:
said strategic alliance partners comprising at least one global transaction bank networked to the system by said common, computer-based technology platform to perform remittance services for said users, said global transaction bank configured for processing cross-national fund transfers between said cash management banks in accordance with said business rules.

14. The distributed remittance system of claim 13:
said strategic alliance partners comprising a global treasury service associated with said global translational bank and configured for monitoring multiple country currency levels in system accounts and adjusting balances so as to manage risks relating to a dynamic foreign exchange market.

15. The distributed remittance system of claim 12:
at least some of said sending agents and receiving agents comprising at least one from among the group consisting of money remittance transfer companies, banks, and financial institutions.

16. A method for making a remittance, comprising:
using a system comprising service providers, strategic alliance partners and ancillary service providers networked together by a common, computer-based technology platform to perform remittance services for users; wherein said users comprise senders intending to make remittances and beneficiaries designated by said senders to receive said remittances; wherein said service providers comprise sending agents accessible by said senders for placing remittance orders and receiving agents having access to said beneficiaries for completing said remittance orders; wherein said technology platform comprises a distributed computer database and a shared set of integral business rules defining selected parameters for compliance checks of all said remittance orders, processes by which said remittance orders may be electronically executed, and an electronic funds transfer gateway for accessing third parties for fund transfers; wherein a said remittance order comprises a tender of payment by a said sender from at least one monetary source from among the group of monetary sources consisting of government-backed currency, negotiable instruments, electronically accessible monetary accounts, and electronically accessible lines of credit; wherein said system comprises web based access for users and agents and electronic forms by which said users may be registered and said remittance orders may be entered into said system; wherein said electronic forms comprise means for identifying at least one unique beneficiary for a said remittance order, and means for identifying a said monetary source for said tender of payment; wherein said business rules incorporate compliance checks for adding new said service providers, strategic alliance partners and ancillary service providers to the system; wherein said business rules incorporate compliance checks for candidate senders, beneficiaries, and remittance transactions, made prior to final approval and execution of said remittance transactions; wherein said business rules incorporate compliance checks for country-specific regulations affecting users and remittance transactions, made prior to final approval and execution of said remittance transactions; wherein said business rules incorporate compliance checks for cross-national regulations affecting users and remittance transactions, made prior to final approval and execution of said remittance transactions; wherein said strategic alliance partners comprise cash management banks networked to the system by said common, computer-based technology platform to perform remittance services for said users, each said sending agent being associated with at least one said cash management bank, each said receiving agent being associated with at least one said cash management bank, each said cash management bank configured for pooling and reporting on said payments from its respective said sending agents and respective said senders, and to its said receiving agents and respective said beneficiaries, in accordance with said business rules; wherein said ancillary service providers comprises at least one best practices company, said best practices company being networked to the system by said common, computer-based technology platform to perform remittance services for said users and configured for processing selected said business rules relating to said compliance checks and reporting compliance status to the system; wherein said ancillary service providers comprises at least one multi-lingual call center networked to the system by said common, computer-based technology platform to perform remittance services for said users and is configured for telecommunications capability with said users, service providers, strategic alliance partners and ancillary service providers, and for processing and distribution of inquiries and answers within the system and between the system and said users; and wherein said business rules provide for agent-initiated requests for settlement, reimbursement, and account reconciliation through the system;
completing an online form for sender registration and submitting it to said system for approval;
conducting within said system selected compliance checks of said sender in accordance with said business rules whereupon when approved, an indication of acceptance is issued;
completing an online form for a remittance order identifying a said beneficiary and identifying a said monetary source for funds for said remittance order and submitting it to said system for execution;
conducting within said system selected compliance checks of said sender, said beneficiary, and said remittance order, in accordance with said business rules;
whereon said compliance checks of said sender, said beneficiary, and said remittance order are completed, transferring funds from said monetary source to said system; and
transferring said funds from said system to said beneficiary.

17. A method for making a remittance according to claim 16, said completing an online form for sender registration and submitting it to said system for approval comprising a sender using web access and completing said online form electronically.

18. A method for making a remittance according to claim 16, said completing an online form for sender registration and submitting it to said system for approval comprising a sender contacting an agent and said agent using web access and completing said online form electronically.

19. A method for making a remittance according to claim 16, said transferring said funds from said system to said beneficiary comprising transferring said funds to a receiving agent and said receiving agent transferring said funds to said beneficiary.

20. A method for making a remittance according to claim 16, said shared set of business rules comprising compliance checks for candidate senders, beneficiaries, and remittance transactions, made prior to final approval and execution of said remittance transactions; compliance checks for country-specific regulations affecting users and remittance transactions, made prior to final approval and execution of said remittance transactions; and compliance checks for cross-national regulations affecting users and remittance transactions, made prior to final approval and execution of said remittance transactions.
